(19) United States
(12) Patent Application Publication
(10) Pub. No.: US 2025/0079503 A1
(43) Pub. Date: Mar. 6, 2025

(54) SOLID-STATE LITHIUM-METAL BATTERIES

(71) Applicant: KING FAHD UNIVERSITY OF PETROLEUM AND MINERALS, Dhahran (SA)

(72) Inventors: Firoz KHAN, Dhahran (SA); Masoud AL-RASHEIDI, Dhahran (SA)

(73) Assignee: KING FAHD UNIVERSITY OF PETROLEUM AND MINERALS, Dhahran (SA)

(21) Appl. No.: 18/456,976

(22) Filed: Aug. 28, 2023

(51) Int. Cl. H01M 10/0562; H01M 10/052; H01M 10/0565

(52) U.S. Cl. CPC H01M 10/0562; H01M 10/052; H01M 10/0565

(57) ABSTRACT

A battery including in order a lithium anode layer, an electrolyte layer including a solid-state electrolyte, and a cathode layer. The cathode layer and the electrolyte layer are adjacent. The solid-state electrolyte includes a polymer matrix, a first lithium salt, and a zeolite. A first portion of the first lithium salt is present in pores of the zeolite to form a lithium loaded zeolite. The lithium loaded zeolite is dispersed in the polymer matrix. A second portion of the first lithium salt is dispersed in the polymer matrix. The cathode layer includes the lithium loaded zeolite, a second lithium salt, a conductive carbon compound, and a binding compound.

### TECHNICAL FIELD

The present disclosure is directed to lithium batteries, and more particularly, to all solid-state lithium-metal batteries.

### DESCRIPTION OF THE RELATED PRIOR ART

The description of the related prior art provided herein is for the purpose of generally presenting the context of the disclosure. Work of the presently named inventors, to the extent described in this background section, as well as aspects of the description which may not otherwise qualify as prior art at the time of filing, are neither expressly nor impliedly admitted as prior art against the present invention.

Lithium (Li) is one of the most popular materials used in anodes of batteries, referred to as lithium metal batteries (LMBs). However, the formation of dendrites due to the irregular electrodeposition of Li can cause short circuits by penetrating through the separator/electrolyte in LMBs. This can lead to organic electrolyte ignition and consequential explosions in LMBs which is a substantial safety hazard. Thus, there is a high demand for solid-state electrolytes (SSE), which can provide a physical barrier to prevent the penetration of Li dendrites, to form all solid state LMBs (ASSLMBs). A sufficient SSE layer has chemical and mechanical stability and adequate Li-ion conductivity.

SSEs are broadly categorized into solid-state inorganic electrolytes (SIEs), solid-state polymer electrolytes (SPEs), and composite solid-state polymer electrolytes (CPEs). SIEs, often referred to as “ceramic electrolytes,” have the highest thermal stability and a among solid electrolytes. However, their use is limited due to interfacial resistance with the electrodes and difficulties in manufacturing. SPEs are typically Li salts dissolved in solid polymer hosts with inherent ion-conduction properties. Additionally, they are considered prospective SSEs owing to their facile synthesis procedure, adequate flexibility, and capability of solvating Li salts. However, due to the low σ(˜10⁻⁶−10⁻⁷ S cm⁻¹ at 25° C.) and low mechanical strength of SPEs, they are unable to suppress Li dendrite formation at the electrolyte/electrode interface. Therefore, CPEs have been developed to combine the advantages of SIEs and SPEs while simultaneously offsetting their disadvantages. Currently, the typical synthesis procedure for CPEs involves mixing metal-organic frameworks (MOFs), various types of metal oxides, and organic molecules or polymer additives into the polymer matrix of SPEs. Thus, enhancements have been achieved in a, the mechanical strength, and thermal stability.

Li-metal is a desirable anode material for rechargeable batteries due to its high theoretical capacity (3,860 milliampere-hours per gram mass (mAh g⁻¹)) and low electrode potential (−3.04 volts (V) versus a standard hydrogen electrode). However, its practical utility is limited by its low plating/stripping Coulombic efficiency (CE). This is mainly due to the thermodynamic instability of the Li/organic electrolyte interface, which arises from the strong reducing ability of Li. The electrode potential of Li lies far outside the potential window of an organic electrolyte, leading to the reductive decomposition of the electrolyte. In certain cases, the reduction products are deposited on the Li surface, forming a Li⁺ conductive but electron-insulating layer known as the solid electrolyte interphase (SEI). The SEI can effectively inhibit further electrolyte decomposition and kinetically expand the potential window.

SEI is commonly regarded as a dominant factor that impacts CE. To maximize the effect of SEIs, various electrolytes have been developed over the past few decades. Initially, solvents like organic carbonates such as propylene carbonate (PC) and ethylene carbonate (EC) were utilized to create SEI. However, the resulting CE, which was below 90%, did not meet the required standard of above 99.9%. After that, ether-based electrolytes like tetrahydrofuran (THF) and 1,2-dimethoxyethane (DME) were used. These electrolytes showed high reduction stabilities, reducing the gap between their potential window and the Li potential, ultimately leading to high CEs. The most recent electrolyte designs focus on SEI stability, which includes concentrated electrolytes, locally concentrated electrolytes with non-polar solvents, and weakly solvating electrolytes. These electrolytes typically use LiN(SO₂F)₂ (LiFSI) to form LiF-rich inorganic SEIs via the preferential reductive decomposition of LiFSI, resulting in high electrochemical and mechanical stability and CEs of ≥99%. However, there is significant variation in CEs, ranging from 90% to 99%, even with similar LiF-rich SEIs, depending on bulk electrolytes. To address the challenges related to the unstable Li-SSE interface, multiple approaches have been implemented, including using interfacial buffer layers to enhance Li wettability, applying external pressure at the MPa to GPa level to mechanically deform Li and reduce void formation, and employing Li metal hosts to improve the uniformity of Li metal plating. However, there still exists a need to improve the compatibility of the interface between the Li anode and the SSE.

Further, although CPEs improve the compatibility with the Li anode, a quick reduction in the capacity of ASSLMBs is observed due to the lack of compatibility between the cathode and CPEs. Although various ASSLMBs have been developed, there remains a need to improve the compatibility of the CPE with the cathode. Therefore, it is one object of the present disclosure to provide an ASSLMB that may eliminate or overcome the aforementioned limitations.

### SUMMARY

In an exemplary embodiment, a battery is described. The battery includes a lithium anode layer, an electrolyte layer including a solid-state electrolyte, and a cathode layer. The cathode layer and the electrolyte layer are adjacent. The solid-state electrolyte includes a polymer matrix, a first lithium salt, and a zeolite. A first portion of the first lithium salt is present in pores of the zeolite to form a lithium loaded zeolite. The lithium loaded zeolite is dispersed in the polymer matrix. A second portion of the first lithium salt is dispersed in the polymer matrix. The cathode layer includes the lithium loaded zeolite, a second lithium salt, a conductive carbon compound, and a binding compound.

In some embodiments, the zeolite has a molar ratio of SiO₂ to Al₂O₃ of 100:1 to 1:1.

In some embodiments, the zeolite has a surface area of 500-1,000 meter square per gram (m²/g) In some embodiments, the lithium loaded zeolite includes 0.1-10 wt. % of the first portion of the first lithium salt, based on a total weight of the lithium loaded zeolite.

In some embodiments, the solid-state electrolyte includes 0.5-30 wt. % of the lithium loaded zeolite, based on a total weight of the polymer matrix.

In some embodiments, the solid-state electrolyte includes 1-60 wt. % of the second portion of the first lithium salt, based on a total weight of the polymer matrix.

In some embodiments, the second lithium salt further includes at least one metal selected from the group consisting of nickel, cobalt, and iron.

In some embodiments, the cathode layer includes 0.5-5 wt. % of the lithium loaded zeolite, based on a total weight of the second lithium salt.

In some embodiments, the cathode layer includes 85-95 wt. % of the second lithium salt, 1-10 wt. % of the conductive carbon compound, and 1-10 wt. % of the binding compound, based on a total weight of the second lithium salt, the conductive carbon compound, and the binding compound.

In some embodiments, the first lithium salt is selected from the group consisting of lithium bis(fluorosulfonyl)imide and lithium bis(trifluoromethanesulfonyl)imide.

In some embodiments, the polymer matrix is selected from the group consisting of polyethylene oxide (PEO), polyvinylidene fluoride (PVDF), polyacrylonitrile (PAN), and derivatives thereof.

In some embodiments, the binding compound is selected from at least one of polyvinylidene fluoride, polytetrafluoroethylene, polyethylene, polyester, polyvinyl alcohol, and as N-methyl-2-pyrrolidone (NMP).

In some embodiments, the conductive carbon compound is at least one selected from the group consisting of graphite, activated carbon, reduced graphene oxide, carbon nanotubes, carbon nanofibers, and carbon black.

In some embodiments, the cathode layer further includes a substrate. A mixture of the lithium loaded zeolite, the second lithium salt, the conductive carbon compound, and the binding compound at least partially coat the substrate.

In some embodiments, the substrate is made from at least one material selected from the group consisting of stainless steel, aluminum, nickel, copper, platinum, zinc, tungsten, and titanium.

In some embodiments, the battery further includes two current collector layers. A first current collector layer is before the lithium anode layer and a second current collector layer is after the cathode layer. The current collector layers are made from at least one material selected from the group consisting of stainless steel, aluminum, nickel, copper, platinum, zinc, tungsten, and titanium.

In some embodiments, the battery further includes a second cathode layer. The second cathode layer is after the cathode layer. The second cathode layer includes the second lithium salt, the conductive carbon compound, and the binding compound.

In some embodiments, the battery has a higher coulombic efficiency than a same battery but the cathode layer does not include the lithium loaded zeolite.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic diagram for Li salt loading on a zeolite surface, according to certain embodiments;

FIG. 2 is a schematic diagram of a conventional full-cell structure, according to certain embodiments;

FIG. 3 is a schematic diagram of a battery in which zeolite is incorporated in a cathode, according to certain embodiments; and

FIG. 4 is a schematic diagram of a battery in which the cathode is composed of two layers, according to certain embodiments.

### DETAILED DESCRIPTION

When describing the present disclosure, the terms used are to be construed in accordance with the following definitions, unless a context dictates otherwise. Embodiments of the present invention will now be described more fully hereinafter with reference to the accompanying drawings wherever applicable, in which some, but not all embodiments of the disclosure are shown.

Further, as used herein, the use of singular includes plural and the words ‘a’, ‘an’ includes ‘one’ and means ‘at least one’ unless otherwise stated in this application.

Furthermore, the terms “approximately”, “approximate”, “about,” and similar terms generally refer to ranges that include the identified value within a margin of 20%, 10%, or preferably 5%, and any values therebetween.

Where a numerical limit or range is stated herein, the endpoints are included. Also, all values and subranges within a numerical limit or range are specifically included as if explicitly written out.

The use of the terms “include,” “includes”, “including,” “have,” “has,” or “having” should be generally understood as open-ended and non-limiting unless specifically stated otherwise.

As used herein the term “cathode” refers to the electrode from which a conventional current leaves a polarized electrical device.

As used herein the term “anode” refers to the electrode from which a conventional current enters a polarized electrical device.

As used herein the term “electrolyte” refers to a medium containing ions that is electrically conducting through the movement of those ions.

As used herein the term “solid-state battery” refers to a battery using solid electrodes and a solid electrolyte, instead of liquid or polymer gel electrolytes.

According to an aspect of the present disclosure, a battery is described. The battery includes a lithium anode layer, an electrolyte layer including a solid-state electrolyte, and a cathode layer. To improve the compatibility of the solid-state electrolyte with the cathode, a zeolite decorated with an Li salt (Li-zeolite) is incorporated into the cathode, which improves the interfacial stability between the cathode and electrolyte. Thus, the performance and durability are improved.

### Lithium Loaded Zeolite

In some embodiments, the battery includes a lithium loaded zeolite, also labeled as Li-zeolite. In some embodiments the Li-zeolite is prepared by dissolving a first Li salt in a solvent to form a solution, and then soaking a zeolite in the solution. In some embodiments, the solution is sonicated during the soaking. In some embodiments, the solution has a temperature of 0 to 60° C., preferably 10-50, 20-40, or about 30° C., during the soaking. In some embodiments, the soaking is for 30 minutes to 24 hours, preferably 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, or 23 hours.

In some embodiments, the solvent is any solvent capable of dissolving the first Li salt. In some embodiments, the solvent is a polar solvent selected from water, methanol, dimethyl sulfoxide, dimethylformamide, acetonitrile, acetic acid, ethylene glycol, acetone, pyridine, ethanol, and diethylene glycol. In a preferred embodiment the solvent is acetonitrile.

In some embodiments, the first lithium salt is selected from the group consisting of lithium bis(fluorosulfonyl)imide and lithium bis(trifluoromethanesulfonyl)imide. In some embodiments, the first lithium salt may include, but is not limited to, lithium tetrafluoroborate, lithium hexafluorophosphate, lithium difluorophosphate, lithium hexafluoroarsenate, lithium perchlorate, lithium trifluoromethanesulfonate, lithium trifluoromethanesulfonylimide, lithium bisoxalato borate, lithium difluorooxalato borate, lithium 12-hydroxystearate, lithium acetate, lithium amide, lithium aspartate, lithium azide, lithium bis(trifluoromethanesulfonyl)imide, lithium borohydride, lithium bromide, lithium carbonate, lithium chlorate, lithium chloride, lithium citrate, lithium cyanide, lithium diphenylphosphide, lithium hexafluorogermanate, lithium hypochlorite, lithium hypofluorite, lithium metaborate, lithium methoxide, lithium naphthalene, lithium niobate, lithium nitrate, lithium nitrite, lithium oxalate, lithium stearate, lithium succinate, lithium sulfate, lithium sulfide, lithium superoxide, lithium tantalate, lithium tetrachloroaluminate, lithium tetrakis(pentafluorophenyl)borate, lithium triflate, and lithium tungstate. In a preferred embodiment, the first lithium salt is lithium bis(fluorosulfonyl)imide (LiTFSI).

Zeolites are microporous, crystalline aluminosilicate materials commonly used as commercial adsorbents and catalysts. Zeolites mainly consist of silicon, aluminum, oxygen, and have the general formula M(AlO₂)(SiO₂)ₓ(H₂O)_{y}, where M is a metal, such as sodium or potassium, or hydrogen and x and y depend on the amount of silica in the zeolite. The Si/Al ratio is variable, which provides a means to tune the properties. Zeolites with Si/Al ratios higher than about 3 are classified as high-silica zeolites, which tend to be more hydrophobic. The H⁺ and Na⁺ can be replaced by diverse cations, because zeolites have ion exchange properties. The nature of the cations influences the porosity of zeolites. The framework is formed by linking of aluminum and silicon atoms by oxides. This linking leads to a 3-dimensional network of Si—O—Al, Si—O—Si, and Al—O—Al linkages. The aluminum centers are negatively charged, which requires an accompanying cation. These cations are hydrated during the formation of the materials. The hydrated cations interrupt the otherwise dense network of Si—O—Al, Si—O—Si, and Al—O—Al linkage, leading to regular water-filled cavities.

In some embodiments, the zeolite has a molar ratio of SiO₂ to Al₂O₃ of 100:1 to 1:1, preferably 90:1, 80:1, 70:1, 60:1, 50:1, 40:1, 30:1, 20:1, or 10:1. In a preferred embodiment, the molar ratio of SiO₂ to Al₂O₃ is 38:1. In some embodiments, the zeolite has a surface area of about 500 meter-square per gram (m²/g), about 510 m²/g, about 520 m²/g, about 530 m²/g, about 540 m²/g, about 550 m²/g, about 560 m²/g, about 570 m²/g, about 580 m²/g, about 590 m²/g, about 600 m²/g, about 610 m²/g, about 620 m²/g, about 630 m²/g, about 640 m²/g, about 650 m²/g, about 660 m²/g, about 670 m²/g, about 680 m²/g, about 690 m²/g, about 700 m²/g, about 710 m²/g, about 720 m²/g, about 730 m²/g, about 740 m²/g, about 750 m²/g, about 760 m²/g, about 770 m²/g, about 780 m²/g, about 790 m²/g, about 800 m²/g, about 810 m²/g, about 820 m²/g, about 830 m²/g, about 840 m²/g, about 850 m²/g, about 860 m²/g, about 870 m²/g, about 880 m²/g, about 890 m²/g, about 900 m²/g, about 910 m²/g, about 920 m²/g, about 930 m²/g, about 940 m²/g, about 950 m²/g, about 960 m²/g, about 970 m²/g, about 980 m²/g, about 990 m²/g, or about 1,000 m²/g. In some embodiments, the zeolite has a surface area preferably 710 m²/g. In some embodiments, the zeolite has a pore size of 0.1-1.0 nm, preferably 0.2 nm, 0.3 nm, 0.4 nm, 0.5 nm, 0.6 nm, 0.7 nm, 0.8 nm, or 0.9 nm.

In an embodiment, the pore is large enough to accommodate a lithium ion which has an ionic radius of about 0.60 nm.

In some embodiments, the zeolite is selected from amicite, analcime, barrerite, brewsterite, chabazite, clinoptilolite, cowlesite, Cu Y zeolite, dachiardite-K, edingtonite, erionite, faujasite, ferrierite, garronite-Ca, gismondine, gmelinite, gonnardite, harmotome, heulandite, hsianghualite, laumontite, mesolite, mordenite, nabesite, natrolite, paulingite, phillipsite, pollucite, scolecite, sodium aluminosilicate, SSZ-13, stellerite, stilbite, thomsonite, ultramarine, wairakite, yugawaralite, zeolite beta, zeolite X, zeolite Y, and ZSM-5. In a most preferred embodiment, the zeolite is zeolite beta. Zeolite beta has a structure including polymorph A and polymorph B. Both polymorphs contain a three-dimensional network of 12-ring pores. Each polymorph grows as a two-dimensional sheet, and the sheets within beta zeolite randomly alternate between the two polymorphs. The intergrowth of the polymorphs has little effect on the pores in two of the dimensions, but in the faulting direction, the pores are tortuous rather than blocked.

In some embodiments, following the soaking, a portion of the first lithium salt is present in pores of the zeolite or on a surface of the zeolite to form a lithium loaded zeolite. In some embodiments, the first lithium salt is only present in pores of the zeolite or only on a surface of the zeolite to form a lithium loaded zeolite. In some embodiments, when the first lithium salt is on a surface of the zeolite it forms a uniform layer over an entire surface of the zeolite.

In some embodiments, the lithium loaded zeolite includes about 0.1 wt. %, about 0.5 wt. %, about 1.0 wt. %, about 1.5 wt. %, about 2.0 wt. %, about 2.5 wt. %, about 3.0 wt. %, about 3.5 wt. %, about 4.0 wt. %, about 4.5 wt. %, about 5.0 wt. %, about 5.5 wt. %, about 6.0 wt. %, about 6.5 wt. %, about 7.0 wt. %, about 7.5 wt. %, about 8.0 wt. %, about 8.5 wt. %, about 9.0 wt. %, about 9.5 wt. %, or about 10 wt. %, of the first lithium salt, based on the total weight of the lithium loaded zeolite. In some embodiments, the lithium loaded zeolite includes up to about 10 wt. %, of the first lithium salt, based on the total weight of the lithium loaded zeolite.

### Solid-State Electrolyte (SSE)

In some embodiments, the battery includes an electrolyte. In a preferred embodiment, the electrolyte is a solid-state electrolyte, thereby forming an all solid state lithium metal battery (ASSLMB). In a most preferred embodiment, the electrolyte is a composite polymer electrolyte (CPE). CPEs include an inorganic filler and a polymer matrix.

In some embodiments, the polymer matrix is selected from one or more of polyethylene oxide (PEO), polyvinylidene fluoride (PVDF), polyacrylonitrile (PAN), and derivatives thereof.

In some embodiments, the polymer matrix may include, but is not limited to, for example, poly(tetrafluoroethylene) (PTFE), poly(methyl methacrylate) (PMMA), poly(methacrylic acid) (PMAA), poly(acrylic acid) (PAA), poly(vinyl methyl ketone), and poly(ethylene terephthalate) (PET), polysulfone (PSf), polyethersulfone (PES), poly(ether sulfone) (PSF), polypropylene (PP), polyimide (PI), and poly(arylene ether nitrile ketone) (PPENK), which can used alone or in combination. In a preferred embodiment, the polymer matrix is PEO.

In some embodiments, the polymer has an average molecular weight of 10,000 to 800,000, preferably 50,000 to 700,000, 100,000 to 600,000, 200,000, to 500,000 g/mol, or 300,000 to 400,000 g/mol. In some embodiments, when the PEO matrix has an average pore size of 100 nm to 2 μm, preferably 300 nm to 1.8 μm, 500 nm to 1.6 μm, 700 nm to 1.4 μm, 900 nm to 1.2 μm, or about 1 μm.

In an embodiment, the lithium loaded zeolite is the filler. In some embodiments, at least one other filler is included in the SSE selected from the group consisting of calcium carbonate, talc, wollastonite, kaolin, silica, carbon black, graphene, dolomite, barium sulfate, aluminum hydroxide, magnesium hydroxide, diatomaceous earth, magnetite, hematite, layered double hydroxide (LDH), halloysite, zinc oxide, and titanium dioxide. In a preferred embodiment, the lithium loaded zeolite is the only filler. The filler at least partially fills at least 10%, preferably 20%, preferably 30%, preferably 40%, preferably 50%, preferably 60%, preferably 70%, preferably 80%, preferably 85%, preferably 90%, or 100% of the pores of the polymer matrix.

In an embodiment, the solid-state electrolyte includes a lithium salt. In some embodiments, the lithium salt is the same or different from the first lithium salt in the lithium loaded zeolite. In a preferred embodiment, the lithium salt is the same as the first lithium salt in the lithium loaded zeolite. In some embodiments, the lithium salt is selected from the group consisting of lithium bis(fluorosulfonyl)imide and lithium bis(trifluoromethanesulfonyl)imide. In some embodiments, the lithium salt may include, but is not limited to, lithium tetrafluoroborate, lithium hexafluorophosphate, lithium difluorophosphate, lithium hexafluoroarsenate, lithium perchlorate, lithium trifluoromethanesulfonate, lithium trifluoromethanesulfonylimide, lithium bisoxalato borate, lithium difluorooxalato borate, lithium 12-hydroxystearate, lithium acetate, lithium amide, lithium aspartate, lithium azide, lithium bis(trifluoromethanesulfonyl)imide, lithium borohydride, lithium bromide, lithium carbonate, lithium chlorate, lithium chloride, lithium citrate, lithium cyanide, lithium diphenylphosphide, lithium hexafluorogermanate, lithium hypochlorite, lithium hypofluorite, lithium metaborate, lithium methoxide, lithium naphthalene, lithium niobate, lithium nitrate, lithium nitrite, lithium oxalate, lithium stearate, lithium succinate, lithium sulfate, lithium sulfide, lithium superoxide, lithium tantalate, lithium tetrachloroaluminate, lithium tetrakis(pentafluorophenyl)borate, lithium triflate, and lithium tungstate. In a preferred embodiment, the first lithium salt is lithium bis(fluorosulfonyl)imide (LiTFSI).

In an embodiment, the lithium loaded zeolite is dispersed in the polymer matrix. In an embodiment, the lithium loaded zeolite is homogeneously dispersed in the polymer matrix. In an embodiment, the lithium salt is also dispersed in the polymer matrix. As referred to throughout, when the lithium salt in the lithium loaded zeolite and the lithium salt in the SSE are the same it is referred to as the first lithium salt, and then a first portion of the first lithium salt is in the lithium loaded zeolite and a second portion of the first lithium salt is dispersed in the polymer matrix.

In some embodiments, the solid-state electrolyte includes about 0.5 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 26 wt. %, about 27 wt. %, about 28 wt. %, about 29 wt. %, of the lithium loaded zeolite, based on the total weight of the polymer matrix. In some embodiments, the solid-state electrolyte includes up to about 30 wt. %, of the lithium loaded zeolite, based on the total weight of the polymer matrix.

The second portion of the first lithium salt is dispersed in the polymer matrix. In some embodiments, the solid-state electrolyte includes about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 26 wt. %, about 27 wt. %, about 28 wt. %, about 29 wt. %, 30 wt. %, about 31 wt. %, about 32 wt. %, about 33 wt. %, about 34 wt. %, about 35 wt. %, about 36 wt. %, about 37 wt. %, about 38 wt. %, about 39 wt. %, about 40 wt. %, about 41 wt. %, about 42 wt. %, about 43 wt. %, about 44 wt. %, about 45 wt. %, about 46 wt. %, about 47 wt. %, about 48 wt. %, about 49 wt. %, about 50 wt. %, about 51 wt. %, about 52 wt. %, about 53 wt. %, about 54 wt. %, about 55 wt. %, about 56 wt. %, about 57 wt. %, about 58 wt. %, about 59 wt. %, of the second portion of the first lithium salt, based on the total weight of the polymer matrix. In some embodiments, the solid-state electrolyte includes up to about 60 wt. %, of the second portion of the first lithium salt, based on the total weight of the polymer matrix.

In a preferred embodiment of the invention the polymer matrix comprises mainly, consists essentially of, or consists of a polyethylene oxide polymer that is functionalized with terminal carboxylate groups. The carboxylate groups are in a salt form with a lithium counter ion. The lithium counter ion may interact with the porous surface of the zeolite and embed therein to provide a close ionic contact between the polymer and the zeolite. The carboxylate group-functionalized polyethylene oxide preferably comprises 0.05-2 wt. %, preferably 0.1-1.5 wt. or 0.25-0.5 wt. % lithium based on the total weight of the carboxylate group-functionalized polymer in salt form. A polyethylene oxide polymer that is functionalized with lithium carboxylate groups at both termini may also effectively bridge different zeolite particles within the polymer matrix or extend substantially across the surface of single zeolite particle across two ionic bonding points. Such interactions help to homogenize the polymer matrix with the lithium and the zeolite and improve ion transport and/or charge storage capability.

In some embodiments, the SSE is made by a method including dissolving the polymer matrix in a solvent to form a solution. Adding the lithium salt to the solution to form a second solution. Adding the lithium loaded zeolite into the second solution to form a third solution. Ball milling the third solution at 50 to 400 rpm, preferably 100-350 rpm, 150-300 rpm, or 200-250 rpm for 2 to 400 hours, preferably 10-300 hours, 20-200 hours, or about 50 hours. Forming a film of the ball milled solution by a method such as dropcasting or spin coating. Annealing the film at a temperature of 30 to 90° C., preferably 40-80, 50-70 or about 60° C. to form the SSE. In some embodiments, the solvent is a polar solvent selected from water, methanol, dimethyl sulfoxide, dimethylformamide, acetonitrile, acetic acid, ethylene glycol, acetone, pyridine, ethanol, and diethylene glycol. In a preferred embodiment the solvent is acetonitrile.

### Cathode

In some embodiments, the battery includes a cathode layer. The cathode layer includes a second lithium salt. In some embodiments, the second lithium salt is different from the first lithium salt in the SSE and the lithium loaded zeolite. In some embodiments, the second lithium salt further includes at least one metal selected from nickel, cobalt, and iron. In some embodiments, the second lithium salt may include, but is not limited to Al, Cu, Ag, Zn, Sn, Sb, Ti, In, V, Cr, Co, C, Ca, Mo, Au, P, W, Rh, Mn, B, Si, Ge, Se, Ln, Ga, and Ir metals. In a preferred embodiment, the second lithium salt is LiFePO₄ (LFP), LiNiCoAlO₂ (NCA), or a combination thereof.

The cathode layer further includes the lithium loaded zeolite. In some embodiments, the cathode layer includes about 0.5 wt. %, about 0.6 wt. %, about 0.7 wt. %, about 0.8 wt. %, about 0.9 wt. %, about 1 wt. %, about 2 wt. %, about 3 wt. %, and about 4 wt. %, of the lithium loaded zeolite, based on the total weight of the second lithium salt. In some embodiments, the cathode layer includes up to about 5 wt. %, of the lithium loaded zeolite, based on the total weight of the second lithium salt.

The cathode layer further includes a binding compound. As used herein, the term ‘binding compound’ refers to the binding material responsible for holding the active material particles within the electrode of a lithium-ion battery (LIB) together to maintain a strong connection between the electrode and the contacts. Such binding materials are normally inert and have an important role in the manufacturability of the battery. In some embodiments, the binding compound is selected from polyvinylidene fluoride, polytetrafluoroethylene, polyethylene, polyester, polyvinyl alcohol, and N-methyl-2-pyrrolidone (NMP). In some embodiments, the binding compound may include but is not limited to, manganese dioxide (MnO₂), nickel hydroxide [Ni(OH)₂], hydrogen storage alloy, lithium cobalt dioxide (LiCoO₂), lithium nickel dioxide (LiNiO₂), lithium manganese dioxide (LiMnO₂), carbon, graphite, an ethylene propylene diene monomer (EPDM).

The cathode layer further includes a conductive carbon compound. In some embodiments, the conductive carbon compound is at least one selected from graphite, activated carbon (AC), reduced graphene oxide (rGO), carbon nanotubes (CNTs), carbon nanofibers (CNFs), and carbon black. In some embodiments, the conductive additive may include but is not limited to, carbide-derived carbon (CDC), carbon aerogel, and graphene. The binding compound and the conductive carbon compound in an electrode impart a firm structure and a continuous conduction path.

In some embodiments, the cathode layer further includes a substrate. In some embodiments, the substrate is made from at least one material selected from the group consisting of stainless steel, aluminum, nickel, copper, platinum, zinc, tungsten, and titanium. In an embodiment, the substrate is deposited partially or wholly with at least one layer of the mixture of the lithium loaded zeolite, the second lithium salt, the conductive carbon compound, and the binding compound in a uniform and continuous manner. In a preferred embodiment, the mixture of the lithium loaded zeolite, the second lithium salt, the conductive carbon compound, and the binding compound form a continuous layer on the substrate. In an embodiment, particles of the mixture of the lithium loaded zeolite, the second lithium salt, the conductive carbon compound, and the binding compound form a monolayer on the substrate. In another embodiment, particles of the mixture of the lithium loaded zeolite, the second lithium salt, the conductive carbon compound, and the binding compound may include more than a single layer on the substrate.

In some embodiments, the cathode layer includes about 85 wt. %, about 86 wt. %, about 87 wt. %, about 88 wt. %, about 89 wt. %, about 90 wt. %, about 91 wt. %, about 92 wt. %, about 93 wt. %, or about 94 wt. % of the second lithium salt, about 1 wt. %, about 2 wt. %, about 3 wt. %, about 4 wt. %, about 5 wt. %, about 6 wt. %, about 7 wt. %, about 8 wt. %, about 9 wt. % of the conductive carbon compound, and about 1 wt. %, about 2 wt. %, about 3 wt. %, about 4 wt. %, about wt. %, about 6 wt. %, about 7 wt. %, about 8 wt. %, about 9 wt. % of the binding compound, based on the total weight of the second lithium salt, the conductive carbon compound, and the binding compound. In some embodiments, the cathode layer includes up to about 95 wt. % of the second lithium salt, up to about 10 wt. % of the conductive carbon compound, and up to about 10 wt. % of the binding compound, based on the total weight of the second lithium salt, the conductive carbon compound, and the binding compound.

In some embodiments, the cathode is made by a method including mixing the binding compound, the conductive carbon compound, and second lithium salt to form a slurry. Mixing the lithium loaded zeolite into the slurry and ball milling at 100-200 rotations per minute (rpm), preferably about 150 rpm for 4 to 24 hours, preferably 5-15 hours, or about 10 hours. Coating the ball milled slurry onto the substrate by use of an automatic coating machine, dropcasting, or spin coating. Drying the coated substrate at a temperature of 100 to 150° C., preferably 110-140, or 120-130° C. for 4 to 24 hours, preferably 5-15 hours, or about 10 hours to form the cathode layer . . . .

Two embodiments of the cathode layer are described herein. A depiction of the first embodiment of the cathode layer is in FIG. 3. In the first embodiment, there is only a single cathode layer which is adjacent to the SSE. In the first embodiment, the cathode includes the lithium loaded zeolite, the second lithium salt, the conductive carbon compound, and the binding compound on the substrate.

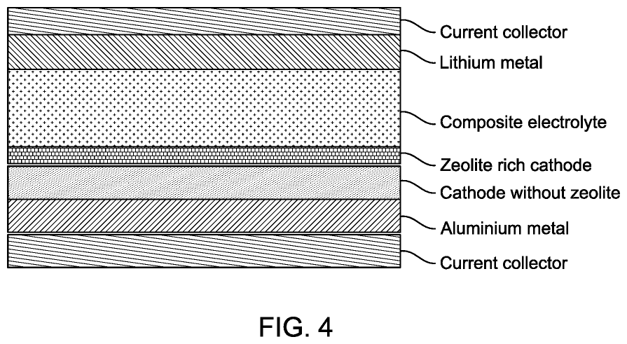

The second embodiment of the cathode layer is depicted in FIG. 4. In the second embodiment, the battery further includes a second cathode layer. The second cathode layer is after and adjacent to the cathode layer. In the second embodiment, the cathode layer is the same as in the first embodiment, and adjacent to the SSE. The second cathode layer includes the second lithium salt, the conductive carbon compound, and the binding compound, but does not include the lithium loaded zeolite.

### Anode

In some embodiments, the battery includes an anode. The anode described herein is not so limited and may be made of any material known to be or later found to be acceptable for use as an anode material. In some preferred embodiments described herein, the anode may be made of a lithium-metal-containing material. The anode may comprise, consist of, or consist essentially of the lithium-metal-containing material. The lithium-metal-containing material may be lithium metal by itself or any alloy comprising lithium. Lithium metal refers to Li metal and not intercalated compound anodes. Examples of alloys comprising lithium include, but are not limited to LiC₆, Li₂₂Si₅, Li₁₅Si₄, Li₂₂Sn₅, LiAl, Li₂₂Pb₅, Li/graphene, Li/Cu, Li/Si, Li/Sn, or Li and any transition metal. The anode may also comprise, consist of, or consist essentially of a mixture of lithium metal alloys or a mixture of lithium metal with one or more lithium metal alloys.

### Battery Structure

In some embodiments, the battery has a layered structure in order as follows: a lithium anode layer, an electrolyte layer comprising a SSE, and a cathode layer. In a preferred embodiment, the cathode layer and the electrolyte layer are adjacent. In a preferred embodiment, the anode layer and the electrolyte layer are adjacent. In a preferred embodiment, each layer is directly next to the following layer without any intervening materials.

In some embodiments, the battery further includes two current collector layers. The first current collector layer is before the lithium anode layer, and the second current collector layer is after the cathode layer. The current collector layers are made from at least one material selected from the group consisting of stainless steel, aluminum, nickel, copper, platinum, zinc, tungsten, and titanium.

In some embodiments, the battery has a higher coulombic efficiency than the same battery, but the cathode layer does not include the lithium loaded zeolite. In some embodiments, the battery has a coulombic efficiency at least 10%, 20%, 30%, 40%, 50%, 60%, 70%, 80%, 90%, or 100% higher than the same battery, but the cathode layer does not include the lithium loaded zeolite. As used herein, the term ‘coulombic efficiency’ refers to the faradaic efficiency or current efficiency, describes the charge efficiency by which electrons are transferred in batteries. CE is the ratio of the total charge extracted from the battery to the total charge put into the battery over a full cycle.

While not wishing to be bound to a single theory, due to the presence of the zeolite in the SSE and in the cathode, the work function of both layers is nearly aligned, thus, Li-ion transportation is easier, which reduces the interface resistance and capacitary fading. Also, in the second embodiment of the cathode as depicted in FIG. 4, the cathode is constructed with two layers. In this structure, the compatibility of the electrolyte is maintained with both the cathode and anode. Moreover, the compatibility of the cathode layer with the substrate is also retained. Overall this structure enhances the compatibility of the SSE with the Li metal, enhances the compatibility of the SSE with the cathode, reduces the interfacial resistances of the cathode and anode with the SSE, reduces the capacity fading, enhances the performance of the ASSLMB, and improves the durability of the ASSLMB.

The battery of the present disclosure may be used in the field of fuel cells, photochemical cells, water splitting cells, electronics, water purification, hydrogen sensors, semiconductors (such as field-effect transistors), magnetic semiconductors, capacitors, data storage devices, biosensors (such as redox protein sensors), photovoltaics, liquid crystal screens, plasma screens, touch screens, OLEDs, antistatic deposits, optical coatings, reflective coverings, anti-reflection coatings, and/or reaction catalysis. In a preferred embodiment, the battery is flexible and included in a wearable device.

The battery case used in the present disclosure may be any of those typically used in the art. The outer shape of the battery case is not particularly limited according to the use of the battery, but may be, for example, a cylindrical shape using a can, an angular shape, a pouch-like shape, or a coin-like shape.

### Other Components

In some embodiments, the electrolyte may also include a redox electrolyte. In some embodiments, the electrolyte may also include an acid. In some embodiments, the electrolyte may also include a solvent. In some embodiments, the electrolyte may include an acid and a solvent. In some embodiments, the acid is a strong acid. Suitable examples of the acid may include, perchloric acid, hydroiodic acid, hydrobromic acid, hydrochloric acid, sulfuric acid, p-toluenesulfonic acid, methanesulfonic acid, or any combination thereof. In some embodiments, the solvent may include tetrahydrofuran, ethyl acetate, dimethylformamide, acetonitrile, acetone, dimethyl sulfoxide, nitromethane, propylene carbonate, ethanol, formic acid, n-butanol, methanol, acetic acid, water, or any combination thereof. The electrolyte may be selected from hydrochloric acid, nitric acid, sulfuric acid, hydrobromic acid, hydroiodic acid, and perchloric acid.

In some embodiments, the battery may include a separator. The separator may be selected from a group including polypropylene (PP) membrane, glass fiber, and cellulose fiber. In some embodiments, the separator may include bacterial cellulose fiber, a polyolefin such as polyethylene (PE), or a combination of PP and PE.

### EXAMPLES

The following examples demonstrate a battery described herein. The examples are provided solely for illustration and are not to be construed as limitations of the present disclosure, as many variations thereof are possible without departing from the spirit and scope of the present disclosure.

### Example 1: Li-Salt Loading of the Zeolite

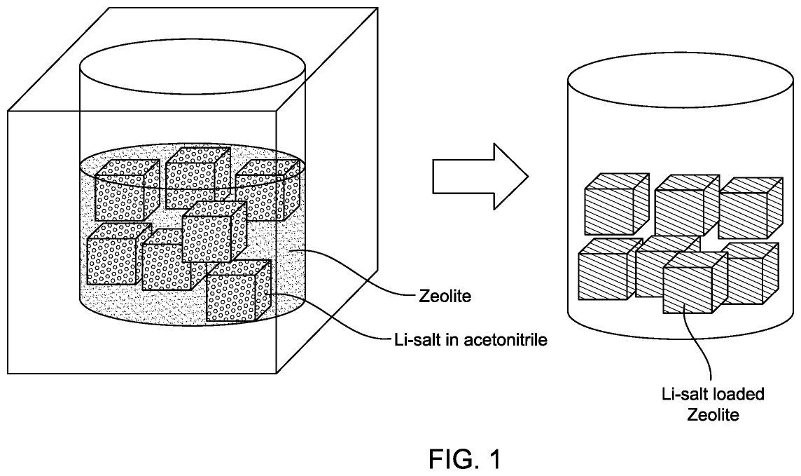

Lithium salt loading is done by sonication of a zeolite dispersed in Li-salt solution, as illustrated in FIG. 1. The Li salt is loaded using ultrasonication for 30 minutes to 24 hours. The lithium salt is dissolved in acetonitrile (10 to 50 milliliters (ml)). The weight ratio of the salt and zeolite is about 0.1 to 10 wt. %. During Li salt loading, heating can also be done in the temperature range of 0 to 60° C. In some examples, Li salt [lithium bis(fluorosulfonyl)imide (LiTFSI)] is dissolved in the acetonitrile (ACN) solvent. The zeolite (Zeolite beta, ammonia, specific surface area 710 m²/g, SiO₂:Al₂O₃ molar ratio 38:1) is soaked in Li solution followed by sonication to deposit a thin layer of Li-salt on the surface of the zeolite, this is labeled throughout as Li-zeolite.

### Example 2: Cathode Formation

A small fraction of the Li-zeolite is added to a LiFePO₄ (LFP) or LiNiCoAlO₂ (NCA) slurry. The LFP slurry is prepared by dispersing 90 wt. % LFP powder, 5 wt. % super P, and 5 wt. % polyvinylidene fluoride (PVDF) powder in N-methyl-2-pyrrolidone (NMP). Then Li-zeolite is added (the weight ratio of zeolite and LFP is 0.5 to 5 wt. %) followed by ball milling at 100-200 rotations per minute (rpm) for 4 to 24 h. Then the slurry is coated on an aluminum foil. The slurry-coated aluminum foil is kept in a vacuum oven at 100 to 150° C. for 4 to 24 h. The controlled sample is prepared without adding zeolite. Similarly, the NCA cathode is formed by replacing NCA powder with LFP powder. The theoretical capacity can be calculated using the mass of the active materials of cathodes.

### Example 3: Synthesis of the Solid State Composite Electrolyte

The composite electrolyte solution is formed by dissolving polyethylene oxide (PEO) (200 to 1000 mg) in ACN solvent (25 ml). Then LiTFSI is added to the mixture. The weight percentage of LiTFSI is about 2 to 60 wt. % of the weight of PEO. Then the Li-zeolite is added to the mixture solution. The content of the zeolite is 0.5 to 30 wt. % of PEO. The mixture is ball milled at 50 to 400 rpm for 2 to 400 h. The mixture solution is cast in Teflon Petri dish and is kept in a nitrogen-flowing isolated box. Then the electrolyte films are annealed at 30 to 90° C.

### Example 4: Battery Fabrication

For the determination of ionic conductivity, the CPE is sandwiched with two stainless steel discs (SSDs). The cell structure is [SSD/CPE/SSD]. For the linear sweep voltammetry (LSV) test to determine the Li transference number, the CPE is sandwiched between SSD and Li foil. The cell structure is [SSD/CPE/Li]. For the compatibility test with the Li anode, the CPE is sandwiched between two Li foils. The cell structure is [Li/CPE/Li]. For full cell fabrication, the CPE is sandwiched between the cathode and Li anode. The cell structure is [cathode/CPE/Li].

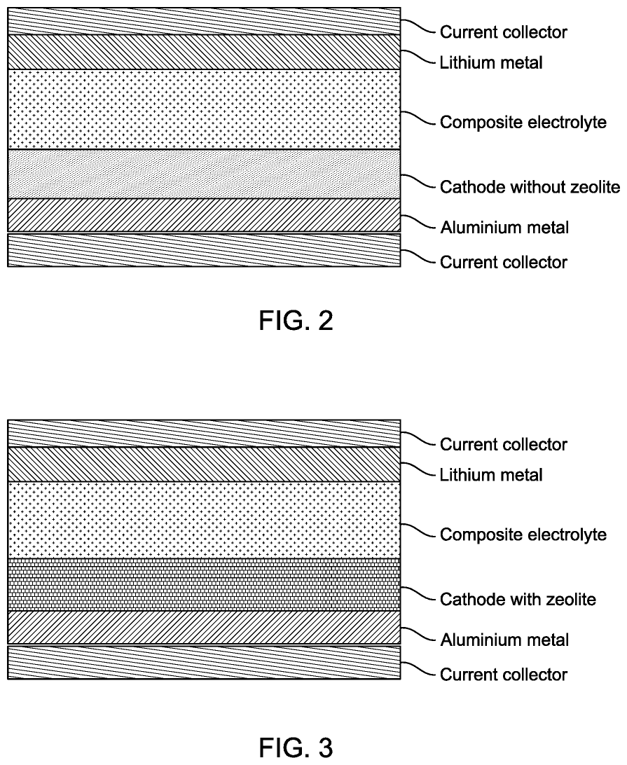

The conventional structure used for full-cell fabrication is illustrated in FIG. 2. A battery with this structure is reported in Jamal H, Khan F, Si H—R, Kim JH. Enhanced compatibility of a polymer-based electrolyte with Li-metal for stable and dendrite-free all-solid-state Li-metal batteries. Journal of Materials Chemistry A. 2021 and Jamal H, Khan F, Hyun S, Min S W, Kim JH. Enhancement of the ionic conductivity of a composite polymer electrolyte via surface functionalization of SSZ-13 zeolite for all-solid-state Li-metal batteries. Journal of Materials Chemistry A. 2021; 9:4126-37. In which the lithium metal, composite electrolyte, and cathode material-coated aluminum foils are cut in the required size of the coin cell. The composite electrolyte is sandwiched between Li metal and cathode (without zeolite). The current collector is used on both sides.

### Example 5: Exemplary Structure 1 (FIG. 3)

In the first exemplary structure, the electrolyte is synthesized by adding Li-zeolite as a filler instead of pristine zeolite. Also, the cathode is formed by the incorporation of Li-zeolite in the cathode slurry. The composite electrolyte is sandwiched between the cathode and Li anode. Due to the presence of the zeolite in the composite electrolyte and in the cathode, the work function of both layers is nearly aligned. Thus, Li-ion transportation is easier, which will help to reduce the interface resistance. Hence, the capacitary fading is reduced.

### Example 6: Exemplary Structure 2 (FIG. 4)

In the second exemplary structure, the cathode is constructed with two layers. The first layer is zeolite-free and is coated on the aluminum foil. The second layer is a zeolite-incorporated cathode. The zeolite-incorporated layer is in contact with the electrolyte. In this structure, the compatibility of the electrolyte is maintained with both the cathode and anode. Moreover, the compatibility of the cathode (first layer) with aluminum metal is also retained.

In the present disclosure, advantages of Exemplary Structures 1 and 2 include, enhancing the compatibility of the composite electrolyte with the Li metal, enhancing the compatibility of the composite electrolyte with the cathode, reducing the interfacial resistances of the cathode and anode with the composite electrolyte, reducing the capacity fading, enhancing the performance of the all-solid-state Li metal batteries, and improving the durability of the all-solid-state Li metal batteries.

Numerous modifications and variations of the present disclosure are possible in light of the above teachings. It is, therefore, to be understood that within the scope of the appended claims, the invention may be practiced otherwise than as specifically described herein.

1. A battery, comprising, in order:
a lithium anode layer;
an electrolyte layer comprising a solid-state electrolyte; and
a cathode layer;
wherein the cathode layer and the electrolyte layer are adjacent,
wherein the solid-state electrolyte comprises:
a polymer matrix;
a first lithium salt; and
a zeolite,
wherein a first portion of the first lithium salt is present in pores of the zeolite to form a lithium loaded zeolite,
wherein the lithium loaded zeolite is dispersed in the polymer matrix,
wherein a second portion of the first lithium salt is dispersed in the polymer matrix,
wherein the cathode layer comprises:
the lithium loaded zeolite;
a second lithium salt;
a conductive carbon compound; and
a binding compound.

2. The battery of claim 1, wherein the zeolite has a molar ratio of SiO₂ to Al₂O₃ of 100:1 to 1:1.

3. The battery of claim 1, wherein the zeolite has a surface area of 500-1,000 meter square per gram (m²/g).

4. The battery of claim 1, wherein the lithium loaded zeolite comprises 0.1-10 wt. % of the first portion of the first lithium salt, based on a total weight of the lithium loaded zeolite.

5. The battery of claim 1, wherein the solid-state electrolyte comprises 0.5-30 wt. % of the lithium loaded zeolite, based on a total weight of the polymer matrix.

6. The battery of claim 1, wherein the solid-state electrolyte comprises 1-60 wt. % of the second portion of the first lithium salt, based on a total weight of the polymer matrix.

7. The battery of claim 1, wherein the second lithium salt further comprises at least one metal selected from the group consisting of nickel, cobalt, and iron.

8. The battery of claim 1, wherein the cathode layer comprises 0.5-5 wt. % of the lithium loaded zeolite, based on a total weight of the second lithium salt.

9. The battery of claim 1, wherein the cathode layer comprises 85-95 wt. % of the second lithium salt, 1-10 wt. % of the conductive carbon compound, and 1-10 wt. % of the binding compound, based on a total weight of the second lithium salt, the conductive carbon compound, and the binding compound.

10. The battery of claim 1, wherein the first lithium salt is selected from the group consisting of lithium bis(fluorosulfonyl)imide and lithium bis(trifluoromethanesulfonyl)imide.

11. The battery of claim 1, wherein the polymer matrix is selected from the group consisting of polyethylene oxide (PEO), polyvinylidene fluoride (PVDF), polyacrylonitrile (PAN), and derivatives thereof.

12. The battery of claim 1, wherein the binding compound is selected from at least one of polyvinylidene fluoride, polytetrafluoroethylene, polyethylene, polyester, polyvinyl alcohol, and as N-methyl-2-pyrrolidone (NMP).

13. The battery of claim 1, wherein the conductive carbon compound is at least one selected from the group consisting of graphite, activated carbon, reduced graphene oxide, carbon nanotubes, carbon nanofibers, and carbon black.

14. The battery of claim 1, wherein the cathode layer further comprises a substrate, and
wherein a mixture of the lithium loaded zeolite, the second lithium salt, the conductive carbon compound, and the binding compound at least partially coat the substrate.

15. The battery of claim 14, wherein the substrate is made from at least one material selected from the group consisting of stainless steel, aluminum, nickel, copper, platinum, zinc, tungsten, and titanium.

16. The battery of claim 1, further comprising two current collector layers,
wherein a first current collector layer is before the lithium anode layer and a second current collector layer is after the cathode layer, and
wherein the current collector layers are made from at least one material selected from the group consisting of stainless steel, aluminum, nickel, copper, platinum, zinc, tungsten, and titanium.

17. The battery of claim 1, further comprising:
a second cathode layer,
wherein the second cathode layer is after the cathode layer, and
wherein the second cathode layer comprises:
the second lithium salt;
the conductive carbon compound; and
the binding compound.

18. The battery of claim 1, wherein the battery has a higher coulombic efficiency than a same battery but wherein the cathode layer does not comprise the lithium loaded zeolite.

19. The battery of claim 1, wherein the polymer matrix is a polyethyleneoxide polymer having terminal carboxylate groups, where the terminal carboxylate groups are salts of lithium.
